(19) United States
(12) Patent Application Publication
(10) Pub. No.: US 2025/0323263 A1
(43) Pub. Date: Oct. 16, 2025

(54) RECHARGEABLE LITHIUM BATTERY

(71) Applicants: SAMSUNG SDI CO., LTD., Yongin-si, Gyeonggi-do (KR); IUCF-HYU (Industry-University Cooperation Foundation Hanyang University), Seoul (KR)

(72) Inventors: Hee Seon CHOI, Yongin-si (KR); Jong-Won LEE, Seoul (KR); Hong Rim SHIN, Seoul (KR); Deok-Hyun Kim, Yongin-si (KR); Youngugk KIM, Yongin-si (KR); Jaehou NAH, Yongin-si (KR); Ilyoung CHOI, Yongin-si (KR)

(21) Appl. No.: 19/089,781

(22) Filed: Mar. 25, 2025

(30) Foreign Application Priority Data
Apr. 11, 2024 (KR) 10-2024-0048822

(51) Int. Cl. H01M 4/587; C01B 32/21; H01M 4/36; H01M 4/62; H01M 10/0525; H01M 10/42

(52) U.S. Cl. CPC H01M 4/587; C01B 32/21; H01M 4/366; H01M 4/62; H01M 10/0525; H01M 10/4235; C01P 2004/32; C01P 2004/50; C01P 2004/86; C01P 2006/40

(57) ABSTRACT

Disclosed is a rechargeable lithium battery and the rechargeable lithium battery including a negative active material including tertiary particles including graphite and aggregates of secondary particles, where the secondary particles include a plurality of primary particles that are aggregated and spheroidized; and an amorphous carbon coating layer surrounding the tertiary particles, the primary particles and the secondary particles being natural graphite; wherein if the rechargeable lithium battery is subjected to high-rate charge and discharge, a difference (X2−X1) between X1 and X2 is about 10 mAh/g or less, the X1 is a constant voltage charge capacity (X1) at which a peak point is appeared in a graph obtained by differentiating (dI1/dQ1) 1^{st} charge capacity (Q1) by current (I1), and the X2 is a constant voltage charge capacity (X2) at which a peak point is appeared in a graph obtained by differentiating (dI2/dQ2) 50^{th} charge capacity (Q2) by current (I2).

### CROSS-REFERENCE TO RELATED APPLICATION

The present application claims priority to and the benefit of Korean Patent Application No. 10-2024-0048822, filed on Apr. 11, 2024, in the Korean Intellectual Property Office, the entire content of which is hereby incorporated by reference.

### BACKGROUND

### 1. Field

Embodiments of the present disclosure relate to a rechargeable lithium battery.

### 2. Description of the Related Art

Recently, with the rapid spread of electronic devices that use batteries, e.g., mobile phones, laptop computers, and electric vehicles, demand for smaller, lighter and relatively high-capacity rechargeable lithium batteries is rapidly increasing. Improving performance of rechargeable lithium batteries has been considered.

Rechargeable lithium batteries may include a positive electrode and a negative electrode including an active material capable of intercalating and deintercalating lithium ions, and an electrolyte solution, and electrical energy is produced by oxidation and reduction reactions if lithium ions are intercalated/deintercalated at the positive and negative electrodes.

### SUMMARY

One or more embodiments of the present disclosure provide a rechargeable lithium battery that exhibits improved high rate characteristics.

One or more embodiments provide a rechargeable lithium battery including a negative electrode including a negative active material, the negative active material including tertiary particles including graphite and aggregates of secondary particles, where the secondary particles are in which a plurality of primary particles are aggregated and spheroidized (e.g., the secondary particles include a plurality of primary particles that are aggregated and spheroidized); and an amorphous carbon coating layer surrounding the tertiary particles, the primary particles and the secondary particles being natural graphite;

wherein if the rechargeable lithium battery is subjected to high-rate charge and discharge, a difference (X2−X1) between X1 and X2 is about 10 mAh/g or less,

the X1 is a constant voltage charge capacity (X1) at which a peak point appears in a graph obtained by differentiating (dI1/dQ1) 1^{st} charge capacity (Q1) by current (I1), and

the X2 is a constant voltage charge capacity (X2) at which a peak point appears in a graph obtained by differentiating (dI2/dQ2) 50^{th} charge capacity (Q2) by current (I2).

A rechargeable lithium battery according to one or more embodiments may exhibit excellent high-rate charge and discharge characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 to FIG. 4 are schematic diagrams showing rechargeable lithium batteries according to some embodiments.

FIG. 5 is a graph showing current and charge capacity obtained in the constant voltage charging period, when the cell of Example 1 is charged at constant current and constant voltage at 3 C.

FIG. 6 is a graph obtained by differentiating the current curve of FIG. 5 with respect to capacity.

FIG. 7 is a graph showing current and charge capacity obtained in the constant voltage charging period, when the cell of Comparative Example 1 is charged at constant current and constant voltage at 3 C.

FIG. 8 is a graph obtained by differentiating the current curve of FIG. 7 with respect to capacity.

### DETAILED DESCRIPTION

Hereinafter, embodiments of the present disclosure are described in more detail. However, these embodiments are examples, the present disclosure is not limited thereto and the present disclosure is defined by the scope of the appended claims and equivalents thereof.

As used herein, if a definition is not otherwise provided, it will be understood that if an element such as a layer, film, region, or substrate is referred to as being “on” another element, it may be directly on the other element or intervening elements may also be present.

Unless otherwise specified in the specification, expressions in the singular include expressions in the plural. Unless otherwise specified, “A or B” may indicate “includes A, includes B, or includes A and B”.

As used herein, the term “combination thereof may include a mixture, a laminate, a complex, a copolymer, an alloy, a blend, a reactant of constituents, and/or a reaction product of reactants or constituents.

As used herein, if a definition is not otherwise provided, a particle diameter may be an average particle diameter. Such a particle diameter indicates an average particle diameter (D50) where a cumulative volume is about 50 volume % in a particle size distribution. The average particle size (D50) may be measured by any suitable method generally used in the art, for example, by a particle size analyzer, and/or by a transmission electron microscopic (TEM) image, and/or a scanning electron microscopic (SEM) image. In some embodiments, a dynamic light-scattering measurement device is used to perform a data analysis, and the number of particles is counted for each particle size range, and from this, the average particle diameter (D50) value may be easily obtained through a calculation. The particle size may be measured by a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In some embodiments, an average particle diameter may be measured by various suitable techniques, and for example, may be measured by a particle analyzer.

In some embodiments, a thickness may be measured by a SEM and/or a TEM image of a cross-section, but is not limited thereto, and it may be measured by any suitable techniques, as long as it may measure a suitable thickness in the related arts. The thickness may be an average thickness.

As used herein, soft carbon refers to graphitizable carbon materials that are readily graphitized by heat treatment at a high temperature, e.g., about 2800° C., and hard carbon refers to non-graphitizable carbon materials that are substantially not or slightly graphitized by heat treatment. The terms soft carbon and hard carbon well understood by a person having ordinary skill in the art upon review of this disclosure.

In some embodiments, the crystalline carbon and the amorphous carbon may be distinguished through an X-ray diffraction (XRD) measurement. The crystalline carbon includes natural graphite and artificial graphite. Natural graphite may indicate graphite which may be naturally generated by separating it from minerals, and if measured by XRD, an interplanar spacing (d002) of the (002) plane may be about 3.350 Å to about 3.360 Å. Artificial graphite may indicate graphite manufactured by graphitization, and if (e.g., when) measured by XRD, an interplanar spacing (d002) of the (002) plane may be about 3.355 Å to about 3.365 Å. In embodiments, the amorphous carbon may have the interplanar spacing (d 002) of the (002) plane of about 3.34 Å or less, if measured by XRD. The XRD may be measured using CuKα ray as a target line with an X-ray diffraction analyzer (e.g., product name: X'Pert, manufacturer: Malvern Panalytical) and by removing a monochromator to improve a peak density resolution. The measurement condition may be 2θ=10° to 80°, a scan speed (°/S) of 0.044 to 0.089, and a step size (°/step) of 0.013 to 0.039.

A rechargeable lithium battery according to one or more embodiments includes a negative electrode including a negative active material, and the negative active material includes tertiary particles including graphite and aggregates of secondary particles, where the secondary particles are in which a plurality of primary particles are agglomerated and spheroidized (e.g., the secondary particles include a plurality of primary particles are agglomerated and spheroidized); and an amorphous carbon coating layer surrounding the tertiary particles, the primary particles and the secondary particles being natural graphite.

In one or more embodiments, if (e.g., when) the rechargeable lithium battery is charged and discharged at high rates, a difference (X2−X1) between X1 and X2 is about 10 mAh/g or less. The X1 is a constant voltage charge capacity (X1) at which a peak point appears in a graph with a y axis (dI1/dQ1) obtained by differentiating 1^{st} charge capacity (Q1) by current (I1), and the X2 is a constant voltage charge capacity (X2) at which a peak point appears in a graph with a y axis (dI2/dQ2) obtained by differentiating 50^{th} charge capacity (Q2) by current (I2). The difference (X2−X1) may be about 3 mAh/g to about 10 mAh/g, about 3 mAh/g to about 8 mAh/g, or about 5 mAh/g to about 10 mAh/g. If the X2−X1 is about 10 mAh/g or less, the high-rate charge and discharge may be allowed without (or substantially without) the deterioration of battery.

The high-rate charge and discharge indicates to about 3 C to about 6 C charge and discharge, e.g., charge and discharge at about 3 C to about 6 C. For example, the high-rate charge and discharge may be performed by constant current charging at a constant current of about 3 C to 6 C and a cut-off voltage of about 4.0 V to about 4.2 V, if (e.g., when) the cut-off voltage is reached, constant voltage charging to about 0.005 C to about 0.03 C, and constant current discharging at about 1 C or less, e.g., more than about 0 C and about 1 C or less. The graph may be obtained from the current and the charge capacity obtained in the constant voltage charge period.

In one or more embodiments, the X1 may be about 15 mAh/g to about 30 mAh/g, about 18 mAh/g to about 28 mAh/g, or about 18 mAh/g to about 25 mAh/g.

The X2 may be about 20 mAh/g to about 40 mAh/g, about 25 mAh/g to about 40 mAh/g, or about 25 mAh/g to about 30 mAh/g.

If the X1 and the X2 satisfy the ranges above, the initial battery resistance may be reduced.

The negative electrode according to one or more embodiments includes a negative active material layer including the negative active material and a current collector supporting the negative active material layer.

The negative active material includes tertiary particles including graphite and aggregates of secondary particles, and an amorphous carbon coating layer surrounding the tertiary particles. As used herein, the term “aggregates” indicates that the secondary particles are aggregated. According to embodiments the secondary particles include a plurality of primary particles that are aggregated and spheroidized. The primary particles and the secondary particles are natural graphite.

The negative active material according to one or more embodiments includes secondary particles including primary particles that are aggregated and spheroidized, and tertiary particles including graphite and aggregates where the secondary particles are aggregated, and the primary particles are pulverized natural graphite that have small size. The primary particles and the secondary particles are natural graphite. In another embodiments, the graphite may be artificial graphite and the graphite may be artificial graphite on the surface of the primary particles and the surface of the secondary particles. Such a negative active material may increase sites for intercalating and deintercalating lithium ions, thereby enabling movement of lithium ions. Thus, the negative active material according to one or more embodiments may exhibit enhanced rapid charge and discharge characteristics.

In one or more embodiments, the natural graphite may be flake natural graphite which may render to more actively occur lithium intercalation. According to one or more embodiments, the flake natural graphite may be flake natural graphite having a small particle size. If natural graphite is flake natural graphite having a small particle size, sites where lithium ions may be intercalated and deintercalated may be further increased in the same area, and passage through which lithium ions may be moved may be further shortened, making it more suitable for rapid charging and discharging.

The negative active material according to some embodiments may be prepared by spheroidizing and bending the small-sized primary particles, and thus, lithium may intercalate into the negative active material, e.g., not only into both ends of the flake natural graphite, but also into the bent portion. As such, the negative active material according to some embodiments may include increased lithium intercalation sites and thus, improved chargeability, especially, high-rate chargeability may be exhibited.

The primary particles may have a particle diameter of about 4 μm to about 8 μm. The particle diameter of the primary particles may be, e.g., about 5 μm to about 8 μm, about 6 μm to about 8 μm, or about 6 μm to about 7 μm.

The secondary particles may have a particle diameter of about 5 μm to about 10 μm. The particle diameter of the secondary particles may be, e.g., about 6 μm to about 10 μm, about 6 μm to about 8 μm, or about 7 μm to about 8 μm.

The tertiary particles may have a particle diameter of about 9 μm to about 15 μm. In one or more embodiments, it may be about 9.2 μm to about 15 μm, or about 9.5 μm to about 15 μm.

If the particle diameter of the primary particles is within the range of about 4 μm to about 8 μm, it may be easily prepared, the cycle-life characteristics may be further improved, and it may be readily applicable for the rechargeable lithium battery. If the particle diameter of the secondary particle is about 5 μm to about 10 μm, it may readily prepare the tertiary particles, and it may be readily applicable for the rechargeable lithium battery. If the particle diameter of the tertiary particles is about 9 μm to about 15 μm, the more excellent initial efficiency may be exhibited and the excellent charge and discharge characteristics of the negative electrode may be exhibited, which may result in ready application for the rechargeable lithium battery.

In the negative active material according to some embodiments, a thickness of the amorphous carbon coating layer may be about 5 nm to about 50 nm, e.g., about 10 nm to about 50 nm, or about 20 nm to about 50 nm. The amorphous carbon coating layer having a thickness within these ranges may more effectively suppress or reduce the side reaction with the electrolyte and may improve the charge and discharge rate capability.

The negative active material including primary particles, the secondary particles and the tertiary particles having these particle diameters and the amorphous carbon coating layer with the above thickness may have a particle diameter of about 9.05 μm to about 16 μm. The particle diameter of the negative active material may be, e.g., about 9.05 μm to about 16 μm, about 9.2 μm to about 15.5 μm, or about 9.5 μm to about 15 μm. If the particle diameter of the negative active material is within these ranges, it may facilitate the intercalation of lithium ions, improving the charge rate capability and exhibiting excellent initial efficiency and cycle-life characteristics. In some embodiments, the secondary particle may be formed by aggregating

a plurality of primary particles. The number of the primary particles is not limited as long as it may form secondary particles, but the secondary particle may be formed by aggregating, e.g., about 2 to about 30, about 2 to about 20, about 2 to about 10, or about 2 to about 4 primary particles. In some embodiments, the tertiary particle is formed by aggregating the secondary particles. The number of the secondary particles is also not limited as long as it may form tertiary particles, but the secondary particle may be formed by aggregating, e.g., about 2 to about 20, about 2 to about 10, or about 2 to about 4 secondary particles.

In some embodiments, an amount of the graphite may be about 9 wt % to about 16.5 wt %, about 9 wt % to about 15 wt %, or about 10 wt % to about 14.5 wt % based on the total 100 wt % of the negative active material. In one embodiment, because the artificial, e.g., artificial graphite may be on a surface of the primary particles and the surface of the secondary particles, the graphite with the amount within the above ranges may make the inside of the negative active material be much denser. The negative active material according to one embodiment includes the secondary particles in which primary particles are aggregated and spheroidized and the tertiary particles in which the secondary particles are aggregated, and thus, graphite, e.g., artificial graphite filled into spaces which may be formed between the particles, for example, artificial graphite filled in the above amounts, may more sufficiently pack the spaces. This may enable the inside of the negative active material to be dense.

In one embodiment, an amount of natural graphite may be about 78.5 wt % to about 89 wt %, about 80 wt % to about 88.5 wt %, or about 80.5 wt % to about 88 wt % based on the total 100 wt % of the negative active material.

The negative active material according to one embodiment may have an orientation index (O.I.) of about 40 to about 70, about 45 to about 70, or about 50 to about 60. The negative active material having an orientation index within these ranges may indicate that it is similarly non-oriented to artificial graphite (e.g., the negative active material has a degree of non-orientation similar to that of artificial graphite), and thus the negative active material according to one or more embodiments may exhibit excellent charge rate capability similar to artificial graphite.

In one or more embodiments, the orientation index may be obtained from an X-ray diffraction analysis using a CuKα ray, e.g., it may be obtained as a ratio (I₀₀₂/I₁₁₀) of a peak intensity at a (002) plane relative to a peak intensity at a (110) plane.

As such, the negative active material according to one or more embodiments may have all advantages or benefits of high capacity, good pression properties and excellent pellet density from use of natural graphite, the improved high-rate charge capability from the increased lithium intercalation sites by including secondary particles in which the small-sized primary particles are agglomerated, and high charge capability of artificial graphite. The effects for improving the charge and discharge rate characteristics by including the amorphous carbon coating layer may also be obtained.

The amorphous carbon may be at least one selected from among soft carbon, hard carbon, mesophase pitch carbide, sintered cokes, or a mixture thereof. In one or more embodiments, an amount of the amorphous carbon may be about 1 wt % to about 5 wt % based on the total 100 wt % of the negative active material.

The negative active material may have a tap density of about 0.8 g/cc to about 1.1 g/cc, e.g., about 0.9 g/cc to about 1.1 g/cc. If the negative active material has the tap density in these ranges, the internal pore volume of the negative active material and the side reaction with an electrolyte may decrease, so as to improve cycle-life characteristics of a battery. In one or more embodiments, the tap density may be obtained by averaging the values obtained from three measurements by applying pressure of about 108 N using a GeoPyc 1360 Pycnometer available from Micromeritics Instruments Corporation, into which a chamber having a diameter of about 19.1 mm and with a conversion factor of 0.2907 cm³/mm is inserted.

The negative active material according to one embodiment may have a mercury cumulative pore volume (Hg Cumulative Pore volume) of about 0.01 mL/g to about 0.07 mL/g, about 0.03 mL/g to about 0.07 mL/g, or about 0.04 mL/g to about 0.07 mL/g. A mercury cumulative pore volume within these ranges may indicate that the pores, e.g., empty spaces inside of the negative active material, are small. The pores measured in the pore volume may have a particle diameter of about 0.01 μm to about 1 μm.

If the mercury cumulative pore volume satisfies these ranges, the amount of the amorphous carbon in the negative active material may be suitable or appropriate, and thus, the excellent negative active material efficiency may be realized. If the mercury cumulative pore volume is within these ranges, the inside of the negative active material may remain dense enough to be well impregnated by the electrolyte, while maintaining suitable or adequate area to react with the electrolyte, and thus, suitable cycle-life characteristics may be exhibited without severe side-reaction.

In some embodiments, the mercury cumulative pore volume may be obtained by adding mercury to the negative active material, applying a pressure of about 0.1 psi to about 60,000 psi to inject mercury into the negative active material, and measuring a change in volume of mercury according to a change in pressure. The change in pressure may be obtained by adjusting the pressure from about 0.1 psi to about 0.2 psi to about 50,000 psi to 60,000 psi.

The rechargeable lithium battery including the negative active material has the (X2−X1) value of about 10 mAh/g or less and thus, while it exhibits high capacity, the high-rate charge and discharge may be allowed to exhibit excellent high-rate characteristics, without (or substantially without) deterioration. Whereas a rechargeable lithium battery using general artificial graphite as a negative active material exhibits the above (X2−X1) values of more than about 10 mAh/g and occurs the abruptly deterioration according to the charge and discharged cycles.

The negative active material may be prepared by the following procedure.

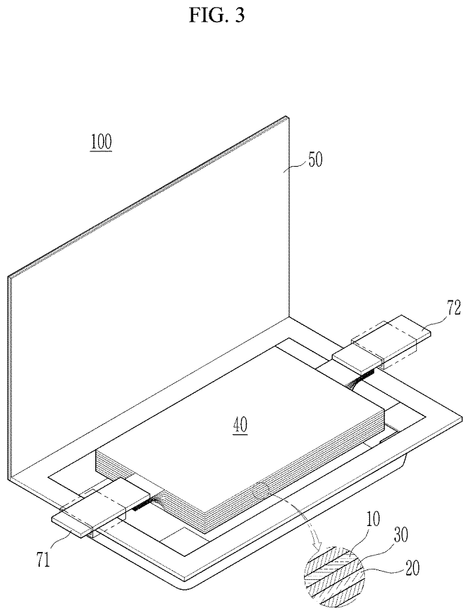

Natural graphite raw material having a particle diameter of about 80 μm or more may be subjected to pulverization and small-sizing to be formed into primary particles (3 of FIG. 3). The natural graphite raw materials may be pulverized into the primary particles by an airstream grinding method. The airstream grinding may be performed by grinding the natural graphite with an airstream under conditions of about 5 kg/cm² to about 20 kg/cm² at a room temperature.

The natural graphite raw material may be a flake natural graphite.

The pulverization and small-sizing may be performed in order to have a particle diameter of primary particles of about 4 μm to about 8 μm, e.g., about 4 μm to about 7 μm, about 4 μm to about 6 μm, or about 5 μm to about 7 μm.

The primary particles may be subjected to spheroidization and aggregation using spheroidizing equipment to prepare secondary particles. The spheroidization and aggregation may be performed in order to have a particle diameter of the secondary particle of about 5 μm to about 10 μm, e.g., about 6 μm to about 10 μm, about 6 μm to about 8 μm, or about 7 μm to about 8 μm.

Thereafter, the secondary particle may be mixed together with the first amorphous carbon precursor to prepare a mixed product. According to this process, the inside of the secondary particle may be made denser.

A second amorphous carbon precursor may be added to the resulting mixed product and to aggregate tertiary particles. The aggregation may be performed by using any suitable aggregation equipment, but is not limited thereto.

The first and the second amorphous carbon precursor may be the same or different from each other, and may be one selected from a phenolic resin, a furan resin, an epoxy resin, polyacrylonitrile, a polyamide resin, a polyimide resin, a polyamide imide resin, synthetic pitch, petroleum pitch, coal pitch, tar, and a combination thereof.

The first and the second amorphous carbon precursor may convert to crystalline carbon, e.g., artificial graphite during the subsequent heat-treatment, and thus, the mixing ratio of the secondary particles, and the first and the second amorphous carbon precursor may be adjusted to have about 10 wt % to about 15% of artificial graphite based on the total 100 wt % of the negative active material in the final product.

The process may allow the first and the second amorphous carbon precursors to be inserted inside of the secondary particles, resulting in it on the surface of primary particles and also the surface of the secondary particles.

The resulting tertiary particles may be primarily heat-treated. The primary heat treatment may be carried out at a suitably high temperature in order to form graphite from the first and the second amorphous carbon precursor, e.g., about 2,800° C. to about 3,000° C. The primary heat treatment may be performed for about 1 hour to about 5 hours, for example, about 1 hour to about 4 hours, or about 1 hour to about 3 hours. According to the process, the first and the second amorphous carbon precursors may be converted into artificial graphite. The first and the second amorphous carbon precursors positioned on the surface of the primary particles and the surface of the secondary particles may be converted into artificial graphite, and thereby artificial graphite may be on these surfaces.

The resulting primary heat treatment product may be coated with a third amorphous carbon precursor. The third amorphous carbon precursor may be one selected from one among a phenolic resin, a furan resin, an epoxy resin, polyacrylonitrile, a polyamide resin, a polyimide resin, a polyamide imide resin, synthetic pitch, petroleum-based pitch, coal-based pitch, tar, and a combination thereof. The third amorphous carbon precursor may be the same as or different from the first and/or the second amorphous carbon precursors.

In the coating, an amount of the third amorphous carbon precursor may be suitably or appropriately adjusted so that the thickness of the amorphous carbon coating layer may be about 5 nm to about 60 nm in the negative active material, as the final product, the negative active material, but is not necessarily limited.

The coated product may be secondarily heat-treated. The secondary heat-treatment may be carried out at about 800° C. to about 2,000° C., e.g., about 800° C. to about 1,800° C., about 800° C. to about 1,600°° C., about 800° C. to about 1,400° C., or about 1,200° C. to about 1,300° C. The secondary heat-treatment may be carried out for about 1 hour to about 5 hours, about 1 hour to about 4 hours, or about 1 hour to about 3 hours.

In the negative electrode according to one or more embodiments, the negative active material layer may further include a binder.

The binder improves binding properties of negative active material particles with one another and with a current collector. The binder may be a non-aqueous binder, an aqueous binder, a dry binder or combination thereof.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be a styrene-butadiene rubber, a (meth) acrylated styrene-butadiene rubber, a (meth)acrylonitrile-butadiene rubber, a (meth)acryl rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or a combination thereof.

The aqueous binder may be a cellulose compound, or may be the cellulose compound together with the aqueous binder. The cellulose compound may be referred to as a thickener, because it may impart or increase viscosity, or it may serve a binder and thus, it may be referred to as a binder. The cellulose compound may be used in a suitable or appropriate amount within the amount of the binder and it is not limited thereto.

The cellulose-based compound includes one or more of carboxymethyl cellulose, hydroxypropylmethyl cellulose, methyl cellulose, or alkali metal salts thereof. The alkali metal may be Na, K, and/or Li.

The dry binder may be a polymer material that is capable of being fibrous (e.g., capable of being fiberized). For example, the dry binder may be polytetrafluoroethylene, polyvinylidene fluoride, a polyvinylidene fluoride-hexafluoropropylene copolymer, polyethylene oxide, or a combination thereof.

In one or more embodiments, an amount of the negative active material may be, based on 100 wt % of the negative active material layer, about 97.5 wt % to about 99.4 wt %, about 97.5 wt % to about 99 wt %, or about 98 wt % to about 99 wt %.

An amount of the binder may be about 0.5 wt % to 5 wt % about based on 100 wt % of the negative active material layer.

The negative active material layer may further include a conductive material (e.g., an electrically conductive material).

The conductive material is included to provide electrode conductivity (e.g., electrical conductivity). Any suitable electrically conductive material may be used as a conductive material unless it causes a chemical change (e.g., an undesirable chemical change in the rechargeable lithium battery). Examples of the conductive material may be a carbonaceous material such as natural graphite, artificial graphite, carbon black, acetylene black, ketjen black, a carbon fiber, a carbon nanofiber, carbon nanotubes, and/or the like; a metal-based material of a metal powder and/or a metal fiber including copper, nickel, aluminum, silver, and/or the like; a conductive polymer (e.g., an electrically conductive polymer) such as a polyphenylene derivative; or a mixture thereof.

If the negative active material layer further includes the binder and the conductive material, an amount of the negative active material may be about 90 wt % to about 99 wt %, an amount of the binder may be about 0.5 wt % to about 5 wt %, and an amount of the conductive material may be about 0.5 wt % to about 5 wt %.

The current collector may include a copper foil, a nickel foil, a stainless steel foil, a titanium foil, a nickel foam, a copper foam, a polymer substrate coated with a conductive metal (e.g., an electrically conductive metal), or a combination thereof.

The negative electrode according to one or more embodiments may have a loading level of about 5.0 mg/cm² to about 8.0 mg/cm², about 6.0 mg/cm² to about 8.0 mg/cm², or about 6.0 mg/cm² to about 7.0 mg/cm². The density of the negative electrode may be about 1.2 g/cc to about 1.8 g/cc, about 1.4 g/cc to about 1.8 g/cc, or about 1.4 g/cc to about 1.6 g/cc. If the loading level and the density of the negative electrode is within these ranges, higher capacity may be exhibited. In one or more embodiments, the loading level may represent a weight of the negative active material layer per the unit area, and it may be determined from the thickness of the negative active material layer. The density of the negative electrode may be measured depending on the pressurization conditions in preparation.

### Rechargeable Lithium Battery

Another embodiment provides a rechargeable lithium battery including a negative electrode, a positive electrode, and an electrolyte.

### Positive Electrode

The positive electrode may include a current collector and a positive electrode active material layer on the current collector. The positive electrode active material layer includes a positive electrode active material and may further include a binder and/or a conductive material (e.g., an electrically conductive material).

For example, the positive electrode may further include an additive that may serve as a sacrificial positive electrode.

An amount of the positive active material may be, about 90 wt % to about 99.5 wt % based on 100 wt % of the positive active material layer, and amounts of the binder and the conductive material may be respectively 0.5 wt % to 5 wt % based on 100 wt % of the positive active material layer.

The positive active material may include a compound (lithiated intercalation compound) that is capable of intercalating and deintercalating lithium. In some embodiments, at least one selected from among a composite oxide of lithium and a metal selected from cobalt, manganese, nickel, or combinations thereof may be used.

The composite oxide may be a lithium transition metal composite oxide, and examples thereof may include lithium nickel-based oxide, lithium cobalt-based oxide, lithium manganese-based oxide, lithium iron phosphate-based compound, cobalt-free nickel-manganese-based oxide, or a combination thereof.

For example, the following compounds represented by any one selected from among the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤0.5, 0≤c≤0.5, 0≤α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

For example, the positive electrode active material may be may be a high nickel-based positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may realize high capacity and may be applied to a high-capacity, high-density rechargeable lithium battery.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, and/or the like, but are not limited thereto.

The conductive material is included to provide electrode conductivity (e.g., electrical conductivity), and any suitable electrically conductive material may be used as a conductive material unless it causes a chemical change (e.g., an undesirable chemical change in the rechargeable lithium battery). Examples of the conductive 1 material may include a carbonaceous material such as natural graphite, artificial graphite, carbon black, acetylene black, Ketjen black, carbon fiber, carbon nanofiber, carbon nanotube, and/or the like; a metal-based material of a metal powder and/or a metal fiber including copper, nickel, aluminum, silver, and/or the like; a conductive polymer (e.g., an electrically conductive polymer) such as a polyphenylene derivative; or a mixture thereof.

The current collector may include Al, but is not limited thereto.

### Electrolyte

The electrolyte includes a non-aqueous organic solvent and a lithium salt.

The non-aqueous organic solvent serves as a medium that transmits ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone, and/or the like. The alcohol-based solvent may include ethanol, isopropyl alcohol, and/or the like and the aprotic solvent may include nitriles such as R-CN (wherein R is a C2 to C20 linear, branched, or cyclic hydrocarbon group, and may include a double bond, an aromatic ring, and/or an ether bond, and/or the like); amides such as dimethylformamide; dioxolanes such as 1,3-dioxolane, 1,4-dioxolane, and/or the like; sulfolanes, and/or the like.

The organic solvent may be used alone or in a mixture of two or more.

If the carbonate-based solvent is used, the cyclic carbonate and the linear carbonate may be used together therewith, and the cyclic carbonate and the linear carbonate may be mixed together at a volume ratio of about 1:1 to about 1:9.

The lithium salt dissolved in an organic solvent supplies a battery with lithium ions, basically operates the rechargeable lithium battery, and improves transportation of the lithium ions between positive and negative electrodes. Examples of the lithium salt include one or at least two supporting electrolyte salt selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y are an integer of 1 to 20, lithium trifluoromethane sulfonate, lithium tetrafluoroethane sulfonate, lithium difluorobis(oxalato)phosphate (LiDFOP), and lithium bis(oxalato) borate (LiBOB).

### Separator

A separator may be between the positive electrode and the negative electrode depending on a type (or kind) of a rechargeable lithium battery. The separator may use polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

The separator may include a porous substrate and a coating layer including an organic material, an inorganic material, or a combination thereof on one or both surfaces (e.g., two opposing surfaces) of the porous substrate.

The porous substrate may be a polymer film formed of any one selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer and/or a (meth)acryl-based polymer.

The inorganic material may be an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed together in one coating layer, or a coating layer including an organic material and a coating layer including an inorganic material may be stacked.

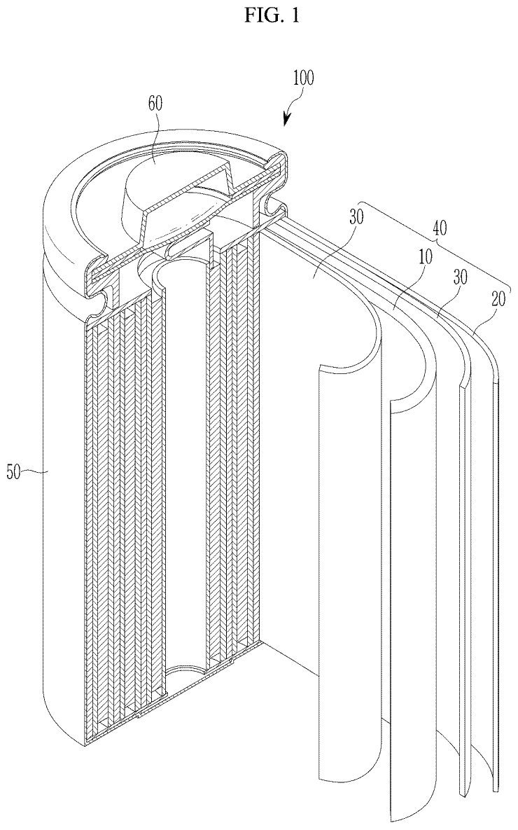

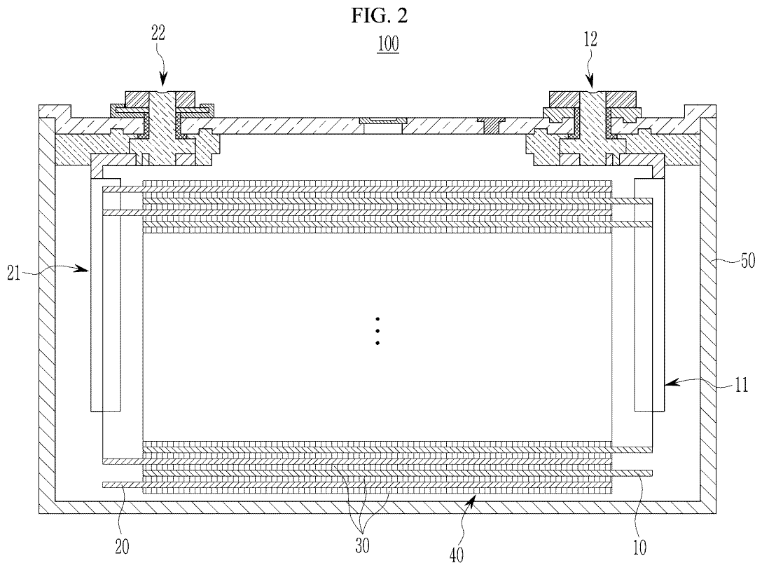

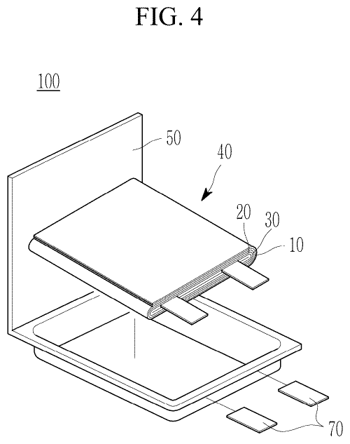

The rechargeable lithium battery may be classified into cylindrical, prismatic, pouch, or coin-type batteries, and/or the like depending on their shape. FIG. 1 to FIG. 4 are schematic views illustrating a rechargeable lithium battery according to an embodiment, and FIG. 1 shows a cylindrical battery, FIG. 2 shows a prismatic battery, and FIG. 3 and FIG. 4 show pouch-type batteries. Referring to FIGS. 1-4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 that seals the case 50, as shown in FIG. 3. In FIG. 3, the rechargeable lithium battery 100 may include a positive electrode lead tab 11 and a positive terminal 12, a negative electrode lead tab 21, and a negative terminal 22. As shown in FIG. 3 and FIG. 4, the rechargeable lithium battery 100 may include an electrode tab 70, which may serve as an electrical path that induces the current formed in the electrode assembly 40 to the outside, for example, a positive electrode tab 71 and a negative electrode tab 72.

The rechargeable lithium battery according to an embodiment may be applied to automobiles, mobile phones, and/or various suitable types (or kinds) of electric devices, as non-limiting examples.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

A flake natural graphite raw material having a particle diameter of 80 μm to 120 μm was airstream ground to prepare small-sized primary particles. The small-sized primary particles were spheroidized and agglomerated by using spheroidizing equipment to prepare secondary particles. The secondary particles were mixed together with a first pitch carbon to prepare a mixed product.

Thereafter, a second pitch carbon was added to the mixed product and agglomerated to prepare tertiary particles.

The prepared tertiary particles were primarily heat treated at 2,800° C. for 2 hours. During the primary heat treatment, the first and the second pitch carbons were graphitized and existed as artificial graphite on the surfaces of the primary particles and the second particles.

The resulting heat-treated product was coated with a third pitch carbon and they were secondarily heat-treated at 1,200° C. for 2 hours to prepare a negative active material.

The prepared negative active material included secondary particles in which primary particles were aggregated and spheroidized, and natural graphite tertiary particles in which the secondary particles were aggregated, artificial graphite on the surface of the primary particles and the surface of the secondary particles, and a soft carbon coating layer surrounding the surface of the tertiary particles.

During preparation, the used amounts of the tertiary particles, the first pitch carbon, the second pitch carbon, and the third pitch carbon were adjusted in order to have an amount of natural graphite of 87 wt %, an amount of artificial graphite of 10 wt % and an amount of the soft carbon coating layer of 3 wt % in the prepared negative active material based on the total 100 wt % of the negative active material.

The prepared primary particles had an average particle diameter (D50) of 4.9 um, the secondary particles had an average particle diameter (D50) of 6.1 μm, the tertiary particles had an average particle diameter (D50) of 10.4 μm, and the negative active material had an average particle diameter (D50) of 10.5 μm and the tap density of 1.66 g/cc.

97.5 wt % of the negative active material, 1.5 wt % of styrene-butadiene rubber binder, and 1.0 wt % of carboxymethyl cellulose thickener were mixed together in a water solvent to prepare a negative active material slurry.

The negative active material slurry was coated on a Cu foil current collector, dried and pressurized to prepare a negative electrode including the current collector and a negative active material layer formed on the current collector, and having the loading level of 6.5 mg//cm² and a density of the negative electrode of 1.55 g/cc.

96 wt % of a LiNi_{0.8}Co_{0.1}Mn_{0.1}O₂ positive active material 96 wt %, 2 wt % of Ketjen black, and 2 wt % of polyvinylidene fluoride were mixed together in an N-methyl pyrrolidone solvent to prepare a positive active material layer slurry. The positive active material layer slurry was coated on an Al foil current collector, dried, and pressurized to prepare a positive electrode.

Using the negative electrode, a positive electrode, and an electrolyte, a full was fabricated. The electrolyte was used a 1.5 M LiPF₆ dissolved in a mixed solvent of ethylene carbonate, ethylmethyl carbonate and dimethyl carbonate (20:10:70 volume ratio).

### Example 2

A full cell was fabricated by substantially the same procedure as in Example 1 that the pressurization condition was adjusted in order to prepare a negative electrode having a loading level of 6.5 mg/cm² and the density of the negative electrode of 1.55 g/cc.

### Comparative Example 1

97.5 wt % of the negative active material, 1.5 wt % of styrene-butadiene rubber binder, and 1.0 wt % of carboxymethyl cellulose thickener were mixed together in a water solvent to prepare a negative active material slurry. The negative active material slurry was coated on a Cu foil current collector, dried and pressurized under a general procedure to prepare a negative electrode including the current collector and a negative active material layer formed on the current collector.

The negative electrode was used to fabricate a full cell by the same procedure as in Example 1.

### Comparative Example 2

Artificial graphite and pitch carbon were mixed together at 98:2 wt % and the mixture was heat-treated at 1,200° C. for 2 hours to prepare a negative active material including artificial graphite and a soft carbon coating layer.

The negative active material was used to fabricate a negative electrode and a half-cell by the same procedure as in Example 1.

### Experimental Example 1) Evaluation of High-rate characteristic

The full cells according to Examples 1 and 2, and Comparative Examples 1 and 2 were charged and discharged at 3 C for 50 cycles. The charging and discharging were performed by constant current charging at 3 C and a cut-off voltage of 4.2 V, constant voltage charging at 4.2 V until the current is reached to 0.01 C, and then constant current discharging at 1 C until the voltage is reached to 2.5 V.

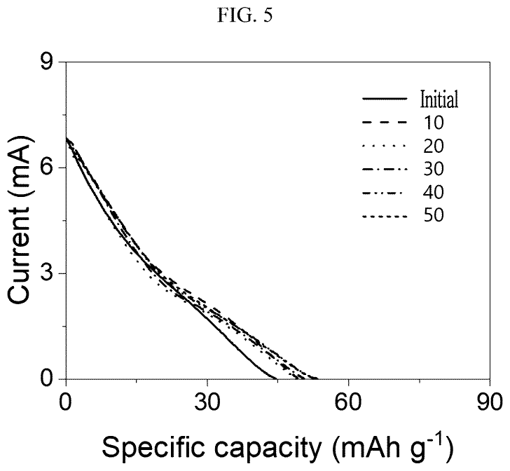

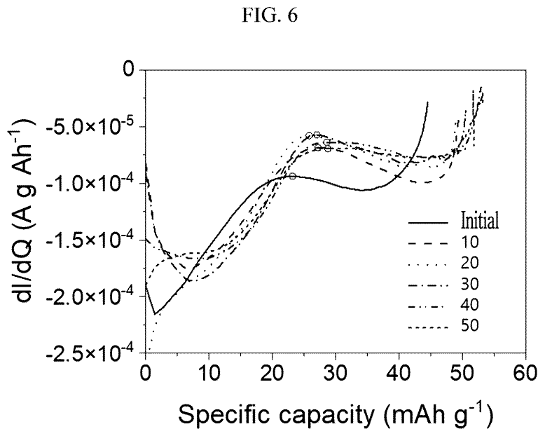

After constant current charging, the current and the charge capacity in the constant voltage charging period was obtained. Among the results, the results at 1^{st} cycle (referred as initial in FIG. 5), 10^{th} cycle, 20^{th} cycle, 30^{th} cycle, 40^{th} cycle, and 50^{th} cycle of Example 1 are shown in FIG. 5. The results obtained by differentiating the current curve of FIG. 5 with respect to current, e.g., the results obtained by differentiating capacity by current are shown in FIG. 6.

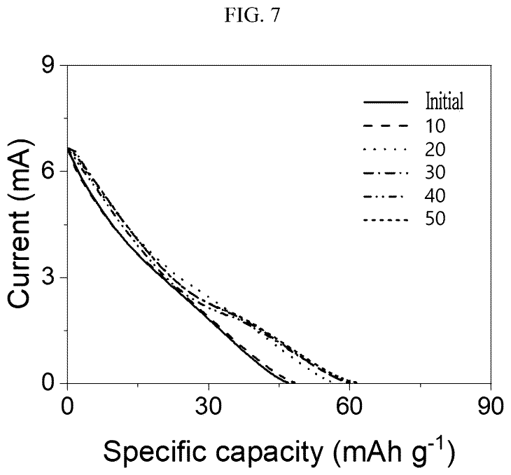

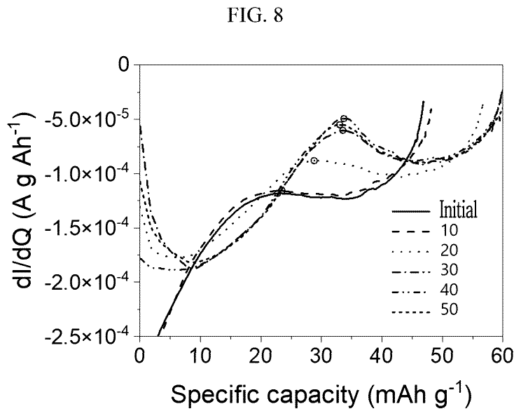

The results at 1^{st} cycle (referred as initial in FIG. 7), 10^{th} cycle, 20^{th} cycle, 30^{th} cycle, 40^{th} cycle, and 50^{th} cycle of Comparative Example 1 are shown in FIG. 7. The results obtained by differentiating the current curve of FIG. 7 with respect to current, e.g., the results obtained by differentiating capacity by current are shown in FIG. 8.

From the results shown in FIG. 6 and FIG. 8, the difference (X2−X1) between the constant voltage charge capacity (X1) at which a peak point appears in a graph obtained by differentiating (dI1/dQ1) 1st charge capacity (Q1) by current (I1) and the constant voltage charge capacity (X2) at which a peak point appears in a graph obtained by differentiating (dI2/dQ2) 50th charge capacity (Q2) by current (I2) was obtained. The results are shown in Table 1. Example 2 and Comparative Example 2 were also performed in the same manner to obtain (X2−X1). The results are shown in Table 1.

The X1 and X2 of Examples 1 and 2, and Comparative Examples 1 and 2 are shown in Table 1.

TABLE 1

| | X1 (mAh/g) | X2 (mAh/g) | X2-X1 (mAh/g) |
|---|---|---|---|
| Example 1 | 23.2 | 28.8 | 5.6 |
| Example 2 | 23.7 | 31.3 | 7.6 |
| Comparative Example 1 | 22.2 | 33.7 | 11.5 |
| Comparative Example 2 | 22.8 | 33.5 | 10.7 |

As shown in Table 1, the (X2−X1) of Examples 1 and 2 are 10 mhA/g or less, but those of Comparative Examples 1 and 2 are more than 10 mhA/g.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims, and equivalents thereof.

1. A rechargeable lithium battery, comprising:
a negative electrode comprising a negative active material, the negative active material comprising tertiary particles comprising graphite and aggregates of secondary particles, where the secondary particles comprise a plurality of primary particles that are aggregated and spheroidized; and an amorphous carbon coating layer surrounding the tertiary particles, the primary particles and the secondary particles comprising natural graphite;
wherein if the rechargeable lithium battery is subjected to high-rate charge and discharge, a difference (X2−X1) between X1 and X2 is about 10 mAh/g or less,
the X1 is a constant voltage charge capacity (X1) at which a peak point appears in a graph obtained by differentiating (dI1/dQ1) 1^{st} charge capacity (Q1) by current (I1), and
the X2 is a constant voltage charge capacity (X2) at which a peak point appears in a graph obtained (dI2/dQ2) by differentiating 50^{th} charge capacity (Q2) by current (I2).

2. The rechargeable lithium battery as claimed in claim 1, wherein the difference (X2−X1) is about 3 mAh/g to about 10 mAh/g.

3. The rechargeable lithium battery as claimed in claim 1, wherein the difference (X2−X1) is about 3 mAh/g to about 8 mAh/g.

4. The rechargeable lithium battery as claimed in claim 1, wherein the X1 is about 15 mAh/g to about 30 mAh/g.

5. The rechargeable lithium battery as claimed in claim 1, wherein the X2 is about 20 mAh/g to about 40 mAh/g.

6. The rechargeable lithium battery as claimed in claim 1, wherein the high-rate charge and discharge is about 3 C to about 6 C charge and discharge.

7. The rechargeable lithium battery as claimed in claim 1, wherein the high-rate charge and discharge is performed by constant current charging at a constant current of about 3 C to about 6 C and a cut-off voltage of about 4.0 V to about 4.2 V, and if the cut-off voltage is reached, constant voltage charging to about 0.005 C to about 0.03 C, and constant current discharging at about 1 C or less.

8. The rechargeable lithium battery as claimed in claim 1, wherein the graphite comprises artificial graphite.

9. The rechargeable lithium battery as claimed in claim 1, wherein the graphite is on a surface of the primary particles and a surface of the secondary particles.

10. The rechargeable lithium battery as claimed in claim 1, wherein the natural graphite comprises flake natural graphite.

11. The rechargeable lithium battery as claimed in claim 1, wherein the amorphous carbon comprises soft carbon, hard carbon, mesophase pitch carbide, sintered coke, or a mixture thereof.

12. The rechargeable lithium battery as claimed in claim 1, wherein the coating layer has a thickness of about 5 nm to about 50 nm.

13. The rechargeable lithium battery as claimed in claim 1, wherein an amount of the natural graphite is about 78.5 wt % to about 89 wt % based on the total 100 wt % of the negative active material.

14. The rechargeable lithium battery as claimed in claim 1, wherein an amount of the graphite is about 9 wt % to about 16.5 wt % based on the total 100 wt % of the negative active material.

15. The rechargeable lithium battery as claimed in claim 1, wherein the negative active material has a tap density of about 0.8 g/cc to about 1.1 g/cc.

16. The rechargeable lithium battery as claimed in claim 1, wherein the negative electrode has a loading level of about 5.0 mg/cm² to about 8.0 mg/cm².

17. The rechargeable lithium battery as claimed in claim 1, wherein the negative electrode has a density of about 1.2 g/cc to about 1.8 g/cc.
